(19) United States
(12) Patent Application Publication
(10) Pub. No.: US 2021/0235661 A1
(43) Pub. Date: Aug. 5, 2021

(54) AIR PURIFIER

(71) Applicant: SHARP KABUSHIKI KAISHA, Sakai City, Osaka (JP)

(72) Inventors: AKIHIRO OKAZAKI, Sakai City, Osaka (JP); YOSHIAKI FUKUDA, Sakai City, Osaka (JP)

(21) Appl. No.: 17/273,902

(22) PCT Filed: Sep. 3, 2019
(86) PCT No.: PCT/JP2019/034590

§ 371 Date: Mar. 5, 2021

(30) Foreign Application Priority Data
Sep. 25, 2018 (JP) 2018-178996

(51) Int. Cl. A01K 1/00; B01D 46/46; B01D 46/44; F24F 11/74; F24F 11/79; F24F 11/52; F24F 8/108

(52) U.S. Cl. CPC A01K 1/0052; B01D 46/46; B01D 46/442; F24F 11/74; F24F 2120/12; F24F 11/52; F24F 8/108; B01D 2279/50; F24F 11/79

(57) ABSTRACT

An air purifier (100) includes a control unit (110). The control unit (110) is configured to acquire occupancy information indicating whether or not a person is in a room. The control unit (110) is configured to switch operational control based on a type of pet specified by a user and the occupancy information. When a person is not in the room, the control unit (110) preferably performs operational control to increase an airflow compared to that when a person is in the room.

### TECHNICAL FIELD

The present invention relates to an air purifier.

BACKGROUND ART

Air purifiers provided with a dust sensor are known (for example, PTL 1). A dust sensor detects an amount of dust in the air. The air purifier described in PTL 1 is configured to change an airflow of a blower in accordance with the amount of dust detected by the dust sensor.

### CITATION LIST

### Patent Literature

PTL 1: JP 2017-124363 A

### SUMMARY OF INVENTION

### Technical Problem

Nevertheless, the air purifier described in PTL 1 only changes the airflow of the blower in accordance with the amount of dust, and is not capable of performing operational control in accordance with a type of pet and person-in-room information.

In light of the foregoing, an object of the present invention is to provide an air purifier capable of operational control in accordance with a type of pet and person-in-room information.

### Solution to Problem

An air purifier according to the present invention includes a control unit. The control unit is configured to acquire occupancy information specifying whether or not a person is in a room. The control unit is configured to switch operational control based on a type of pet specified by a user and the occupancy information.

### Advantage Effects of Invention

According to an air purifier according to the present invention, it is possible to perform operational control in accordance with a type of pet and person-in-room information.

### BRIEF DESCRIPTION OF DRAWINGS

FIG. 1 is a block diagram of an air purification system including an air purifier according to a first embodiment of the present invention.

FIG. 2 is a flowchart illustrating a method of controlling the air purifier according to the first embodiment of the present invention.

FIG. 3 is a table illustrating operational control of a control unit in a first operation mode, a second operation mode, a third operation mode, and a fourth operation mode.

FIGS. 4(a) and (b) are diagrams illustrating a mobile terminal.

FIG. 5 is a block diagram of an air purification system including an air purifier according to a second embodiment of the present invention.

FIG. 6 is a block diagram of an air purification system including an air purifier according to a third embodiment of the present invention.

### DESCRIPTION OF EMBODIMENTS

Embodiments of the present invention will be described hereinafter with reference to the drawings. Note that, in the drawings, the same or equivalent components are denoted by the same reference signs and description thereof will not be repeated.

### First Embodiment

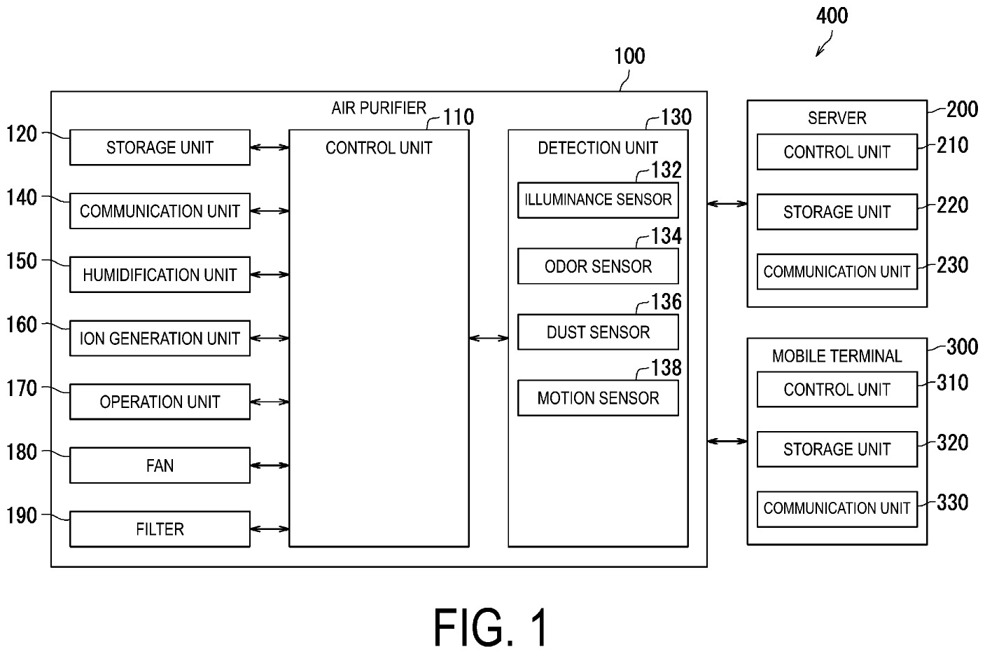

An air purifier 100 according to a first embodiment of the present invention will be described with reference to FIG. 1. FIG. 1 is a block diagram of an air purification system 400 including the air purifier 100 according to the first embodiment of the present invention.

As illustrated in FIG. 1, the air purification system 400 includes the air purifier 100, a server 200, and a mobile terminal 300.

The air purifier 100 includes a control unit 110, a storage unit 120, a detection unit 130, a communication unit 140, a humidification unit 150, an ion generation unit 160, an operation unit 170, a fan 180, and a filter 190.

The control unit 110 is a hardware circuit including a processor such as a central processing unit (CPU), an application specific integrated circuit (ASIC), and the like. The control unit 110 controls the operation of each unit of the air purifier 100 by the processor reading and executing a control program stored in the storage unit 120. The control unit 110 acquires occupancy information. The occupancy information is information indicating whether or not a person is in a room. For example, the control unit 110 acquires the occupancy information based on a detection result of a motion sensor 138 or position information acquired by a global positioning system (GPS) function of the mobile terminal 300.

The storage unit 120 includes a random access memory (RAM) and a read only memory (ROM). The storage unit 120 stores various data and a control program for controlling the operation of each unit of the air purifier 100. The control program is executed by the control unit 110.

The detection unit 130 periodically detects environment information. For example, the detection unit 130 detects the environment information every 15 minutes. The environment information indicates information regarding the environment surrounding the air purifier 100. The detection unit 130 detects a plurality of environment information. The environment information includes, for example, illuminance information, odor information, dust information, and position information of a user. The environment information detected by the detection unit 130 is transmitted to the server 200 via the communication unit 140. The server 200 stores the environment information in the storage unit 220. That is, the storage unit 220 of the server 200 stores a history of the environment information.

The detection unit 130 includes an illuminance sensor 132, an odor sensor 134, a dust sensor 136, and the motion sensor 138. Sensitivity of the detection unit 130 is controlled by the control unit 110. The sensitivity of the detection unit 130 can be controlled, for example, at three stages of “high”, “standard”, and “low”, in order of decreasing sensitivity.

The illuminance sensor 132 detects an illuminance inside the room in which the air purifier 100 is installed.

The odor sensor 134 detects an odor level in the room in which the air purifier 100 is installed. The odor sensor 134 is, for example, a quartz, vibration type sensor or a semiconductor type sensor.

The dust sensor 136 detects an amount of dust in the room in which the air purifier 100 is installed. The dust sensor 136 is capable of distinguishing and detecting fine dust of less than 2.5 μm and large dust (PM 2.5) of 2.5 μm or greater.

The motion sensor 138 detects whether or not a person is in the room in which the air purifier 100 is installed. That is, the motion sensor 138 detects the occupancy information.

The communication unit 140 is capable of communicating with an electronic device equipped with a communicator that utilizes the same communication system (protocol). In this embodiment, the communication unit 140 communicates with the server 200 and the mobile terminal 300 via a network such as a local area network (LAN). The communication unit 140 is a communication module (communication device) such as a LAN board, for example. The communication unit 140 transmits the environment information detected by the detection unit 130 to the server 200, for example.

The humidification unit 150 humidifies the room in which the air purifier 100 is installed. The humidification unit 150 includes a water tank (not illustrated). The humidification unit 150 vaporizes water contained in the water tank and moistens the air to humidify the room.

The ion generation unit 160 generates and discharges ions into the air inside the room. The ion generation unit 160 is detachable from a main body of the air purifier 100.

The operation unit 170 is, for example, a touch panel. The operation unit 170 displays an image. Specifically, the operation unit 170 displays various information such as an operating state of the air purifier 100. Further, the operation unit 170 receives an operation from the user. The operation unit 170 can be switched on and off.

The fan 180 takes the air that exists in the room in which the air purifier 100 is installed into the air purifier 100, and passes the air through the filter 190. As a result, the filter 190 collects dust present in the air. The filter 190 is, for example, a high efficiency particulate air (HEPA) filter. An airflow of the fan 180 is controlled by the control unit 110.

The server 200 includes a control unit 210, a storage unit 220, and a communication unit 230.

The control unit 210 is a hardware circuit including a processor such as a CPU, an ASIC, and the like. The control unit 210 controls the operation of each unit of the server 200 by the processor reading and executing a control program stored in the storage unit 220.

The storage unit 220 includes a RAM and a ROM. The storage unit 220 stores various data and a control program for controlling the operation of each unit of the server 200. The control program is executed by the control unit 210.

The communication unit 230 is capable of communicating with an electronic device equipped with a communicator that utilizes the same communication system (protocol). In this embodiment, the communication unit 230 communicates with the air purifier 100 via a network such as a LAN. The communication unit 230 is a communication module (communication device) such as a LAN board, for example.

The mobile terminal 300 includes a control unit 310, a storage unit 320, and a communication unit 330. The mobile terminal 300 is, for example, a smartphone. The mobile terminal 300 has a GPS function.

The control unit 310 is a hardware circuit including a processor such as a CPU, an ASIC, and the like. The control unit 310 controls the operation of each unit of the mobile terminal 300 by the processor reading and executing a control program stored in the storage unit 320.

The storage unit 320 includes a RAM and a ROM. The storage unit 320 stores various data and a control program for controlling the operation of each unit of the mobile terminal 300. The control program is executed by the control unit 310.

The communication unit 330 is capable of communicating with an electronic device equipped with a communicator that utilizes the same communication system (protocol). In this embodiment, the communication unit 330 communicates with the air purifier 100 via a network such as a LAN.

The air purifier 100 has four operation modes. Specifically, the air purifier 100 switches operational control based on a type of pet and the occupancy information. The type of pet is specified by the user. For example, the type of pet is specified by the user operating the operation unit 170 or the mobile terminal 300.

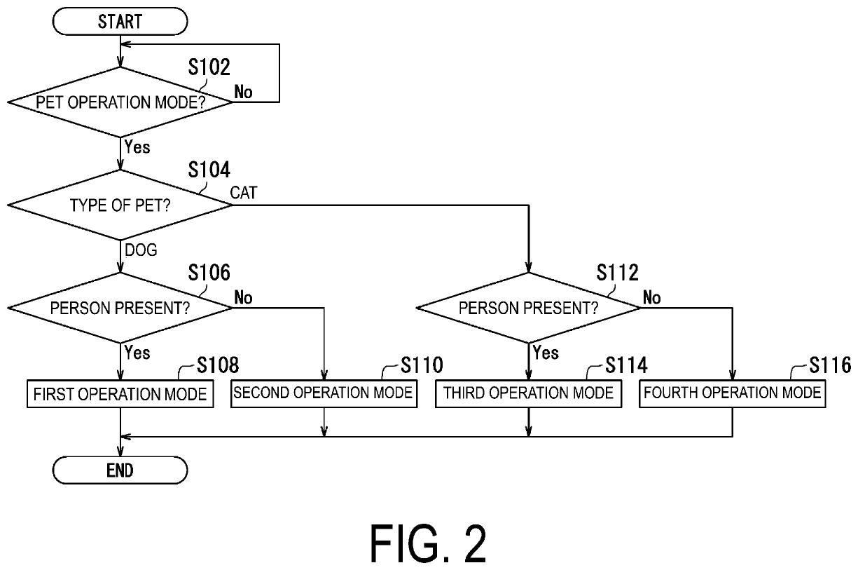

A method of controlling the air purifier 100 according to the present invention will be described with reference to FIG. 1 and FIG. 2. FIG. 2 is a flowchart illustrating the method of controlling the air purifier 100 according to the first embodiment of the present invention. The operation mode is switched by execution of the processing of step S102 to step S116 illustrated in FIG. 2.

Step S102: The control unit 11 determines whether or not the mode is a pet operation mode. When the control unit 110 determines that the mode is not the pet operation mode (step S102: No), the processing returns to step S102. When the control unit 110 determines that the mode is the pet operation mode (step S102: Yes), the processing proceeds to step S104.

Step S104: The control unit 110 determines the type of pet. When the control unit 110 determines that the type of pet is cat (step S104: Cat), the processing proceeds to step S112. When the control unit 110 determines that the type of pet is dog (step S104: Dog), the processing proceeds to step S106.

Step S106: The control unit 10 determines whether a person is in the room. the control unit 110 determines that a person is not in the room (step S106: No), the processing proceeds to step S110. When the control unit 110 determines that a person is in the room (step S106: Yes), the processing proceeds to step S108.

Step S108: The control unit 110 switches the operation mode to a first operation mode. The first operation mode is an operation mode suitable when a person is in the room and the type of pet is dog. The processing ends.

Step S110: The control unit 110 switches the operation mode to a second operation mode, The second operation mode is an operation mode suitable when a person is not present and the type of pet is dog. The processing ends.

Step S112: The control unit 110 determines whether a person is in the room. If the control unit 110 determines that a person is not in the room (step S112: No), the processing proceeds to step S116. When the control unit 110 determines that a person is in the room (step S112: Yes), the processing proceeds to step S114.

Step S114: The control unit switches the operation mode to a third operation mode. The third operation mode is an operation mode suitable when a person is in the room and the type of pet is cat. The processing ends.

Step S116: The control unit 110 switches the operation mode to a fourth operation mode. The fourth operation mode is an operation mode suitable when a person is not present and the type of pet is cat. The processing ends.

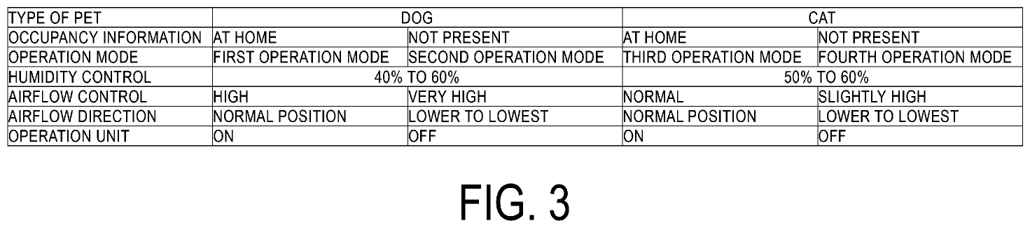

The operation modes will be further described with reference to FIG. 3. FIG. 3 is a table illustrating the operational control of the control unit 110 in the first operation mode, the second operation mode, the third operation mode, and the fourth operation mode.

As illustrated in FIG. 3, the control unit 110 changes the operational control and thus the humidity in accordance with the type of pet. In this embodiment, in the case of the first operation mode and the second operation mode, the control unit 110 controls the humidification unit 150 such that the humidity is from 40% to 60%. That is, when the type of pet is dog, the control unit 110 controls the humidification unit 150 such that the humidity is from 40% to 60%. On the other hand, in the case of the third operation mode and the fourth operation mode, the control unit 110 controls the humidification unit 150 such that the humidity is from 50% to 60%. That is, when the type of pet is cat, the control unit 110 controls the humidification unit 150 such that the humidity is from 50% to 60%. In this way, compared to when the type of pet is dog, the control unit 110 controls the humidification unit 150 and thus increases the humidity compared to that when the type of pet is cat. This is because the optimal humidity zone differs for dogs and cats.

Further, in the first operation mode, the control unit 110 controls the fan 180 such that the airflow is “high”. In the second operation mode, the control unit 110 controls the fan 180 such that the airflow is “very high”. That is, when a person is not in the room, the control unit 110 performs operational control such that the airflow is increased compared to that when a person is in the room.

In the third operation mode, the control unit 110 controls the fan 180 such that the airflow is “normal”. In the fourth operation mode, the control unit 110 controls the fan 180 such that the airflow is “slightly high”. That is, when a person is not in the room, the control unit 110 performs operational control such that the airflow is increased compared to that when a person is in the room.

In this way, when a person is not in the room, the control unit 110 performs operational control and thus the airflow is increased compared to that when a person is in the room. Accordingly, by controlling air purification at a higher level of operation while a person is not present, it is possible to ensure that the air is in a clean state when a person returns to the room. Further, by setting air purification to a lower level of operation while a person is at home, it is possible to suppress an operation sound.

Further, in the first operation mode, the control unit 110 controls the fan 180 such that the airflow is higher than that in the third operation mode. Further, in the second operation mode, the control unit 110 controls the fan 180 such that the airflow is higher than that in the fourth operation mode. That is, when the type of pet is dog, the control unit 110 controls the fan 180 such that the airflow is higher compared to that when the type of pet is cat. This is because cats are more vulnerable to airflow than dogs.

Further, in the first operation mode and the third operation mode, the control unit 110 performs control such that an airflow direction is in a normal position. In the second operation mode and the fourth operation mode, the control unit 110 performs control such that the airflow direction is at a lowest position. In this way, when a person is not in the room, the control unit 110 performs operational control such that the airflow direction is lower than that when a person is in the room.

Further, in the first operation mode and the third operation mode, the control unit 110 controls the operation unit 170 and thus turns on the operation unit 170. That is, when a person is in the room, the control unit 110 controls the operation unit 170 and thus turns on the operation unit 170. On the other hand, in the second operation mode and the fourth operation mode, the control unit 110 controls the operation unit 170 and thus turns off the operation unit 170. That is, when a person is not in the room, the control unit 110 controls the operation unit 170 and thus turns off the operation unit 170. In this way, when a person is not in the room, the control unit 110 performs control and thus turns off the operation unit 170. Accordingly, power consumption can be suppressed.

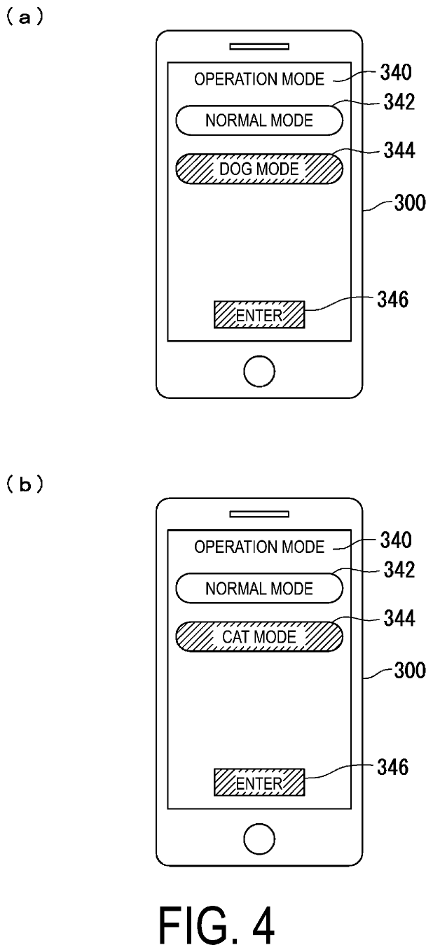

A method of setting the pet operation mode will be described with reference to FIG. 4(a) and FIG. 4(b). FIG. 4(a) and FIG. 4(b) are diagrams illustrating the mobile terminal 300.

As illustrated in FIG. 4(a) and FIG. 4(b), the mobile terminal 300 further includes a display unit 340. A normal mode selection button 342, a pet mode selection button 344, and an enter button 346 are displayed on the display unit 340. A pet mode corresponding to the type of pet specified by the user is displayed on the pet mode selection button 344. In FIG. 4(a), because dog is specified as the type of pet by the user, “Dog mode” is displayed on the pet mode selection button 344. In FIG. 4(b), because cat is specified as the type of pet by the user, “Cat mode” is displayed on the pet mode selection button 344. After selection of the pet mode selection button 344, the enter button 346 is selected, setting the pet operation mode.

As described with reference to FIG. 1 to FIG. 4, the control unit 110 is configured to switch operational control based on the type of pet specified by the user and the occupancy information. Accordingly, it is possible to perform operational control in accordance with the type of pet and the person-in-room information.

Further, when a person is not in the room, the control unit 110 is configured to perform operational control and thus increase the airflow compared to that when a person is in the room. Accordingly, by controlling air purification at a higher level of operation while a person is not present, it is possible to ensure that the air is in a clean state when a person returns to the room. Further, by setting air purification to a lower level of operation while a person is at home, it is possible to suppress an operation sound.

Furthermore, the control unit 110 is configured to change operational control and thus change the airflow in accordance with the type of pet. Accordingly, it is possible to perform operational control at an airflow in accordance with the type of pet.

Further, the control unit 110 is configured to change operational control and thus change the humidity in accordance with the type of pet. Accordingly, it is possible to perform operational control at a humidity in accordance with the type of pet.

Further, when a person is not in the room, the control unit 110 is configured to perform control and thus turn off the operation unit 170. Accordingly, power consumption can be suppressed.

### Second Embodiment

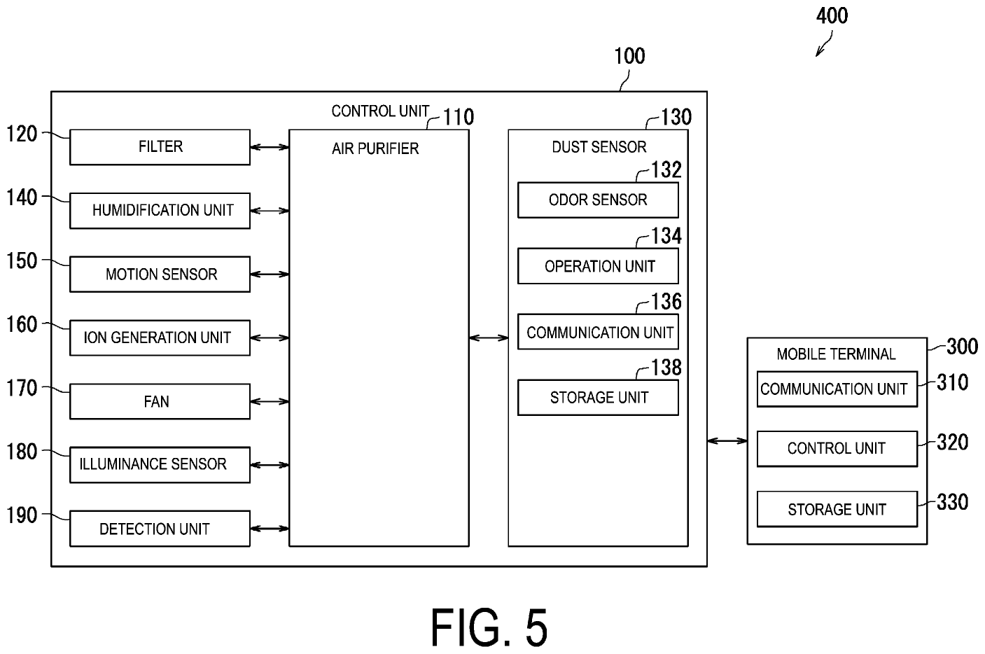

The air purifier 100 according to a second embodiment of the present invention will be described with reference to FIG. 5. FIG. 5 is a block diagram of the air purification system 400 including the air purifier 100 according to the second embodiment of the present invention. The air purification system 400 according to the second embodiment has the same configuration as that of the air purification system 400 according to the first embodiment, except that the air purification system 400 according to the second embodiment does not include the server 200, and thus duplicate descriptions will be omitted.

As illustrated in FIG. 5, the air purification system 400 includes the air purifier 100 and the mobile terminal 300.

In this embodiment, the server 200 is not provided. The history of the environment information is stored in the storage unit 120 of the air purifier 100. In this embodiment as well, as in the first embodiment, operational control can be performed in accordance with the type of pet and the person-in-room information.

### Third Embodiment

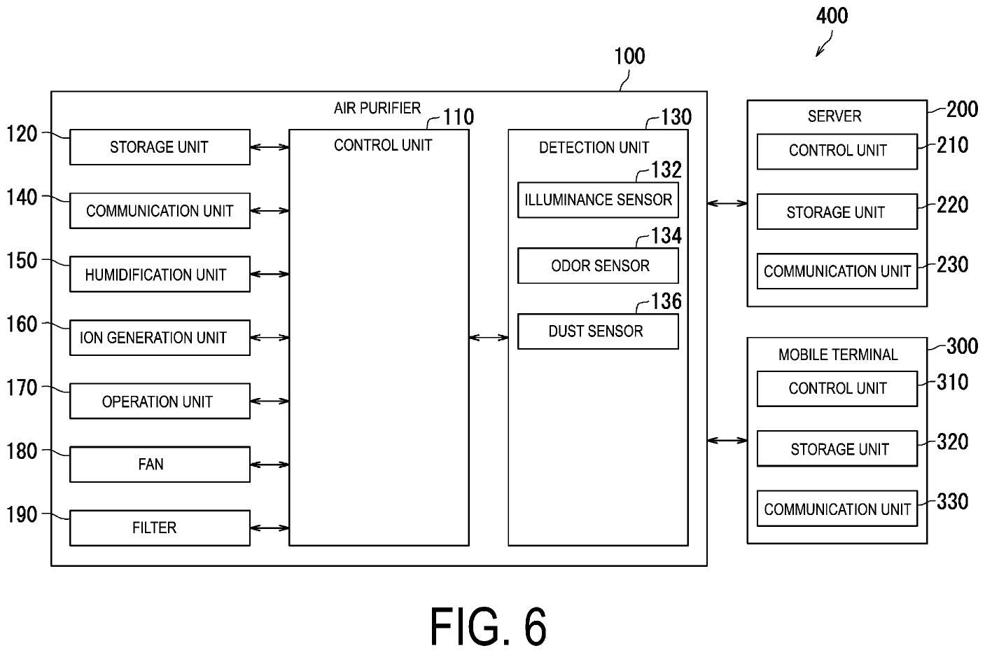

The air purifier 100 according to a third embodiment of the present invention will be described with reference to FIG. 6. FIG. 6 is a block diagram of the air purification system 400 including the air purifier 100 according to the third embodiment of the present invention. The air purifier 100 according to the third embodiment has the same configuration as that of the air purifier 100 according to the first embodiment, except that the air purifier 100 according to the third embodiment does not include the motion sensor 138, and thus duplicate descriptions will be omitted.

As illustrated in FIG. 6, the air purification system 400 includes the air purifier 100, the server 200, and the mobile terminal 300.

In this embodiment, the air purifier 100 does not include the motion sensor 138. In this embodiment, the control unit 110 determines whether or not the user is in the room in which the air purifier 100 is installed by the GPS function of the mobile terminal 300. Specifically, based on the position information of the mobile terminal 300 indicated by the GPS function of the mobile terminal 300, the control unit 110 determines whether or not a distance between the air purifier 100 and the mobile terminal 300 is within a predetermined range, and determines whether or not the user is in the room in which the air purifier 100 is installed. In this embodiment as well, similar to the first embodiment and the second embodiment, operational control can be performed in accordance with the type of pet and the person-in-room information.

In the description above, embodiments of the present invention have been described with reference to the drawings (FIG. 1 to FIG. 6). Note that the present invention is not limited to the embodiments described above, and can be carried out in the form of various aspects within the scope not departing from the gist of the present invention (for example, (1) to (2) described below). The drawings primarily schematically illustrate each of the constituent elements for the sake of easier understanding, and the thickness, length, number, and the like of each of the illustrated constituent elements are different from the actual thickness, length, number, and the like by reason of making of the drawings. Further, the material, shape, dimensions, and the like of each of the constituent elements illustrated in the embodiments described above are merely exemplary and are not particularly limiting, and various modifications can be made within the scope not departing from the effects of the present invention in essence.

(1) While there are two types of pets, namely, a dog and a cat described with reference to FIG. 1 to FIG. 6, the present invention is not limited thereto. For example, there may be three or more types of pets.

(2) While the control unit 110 switches operational control based on whether the pet is a dog or a cat as described with reference to FIG. 1 to FIG. 6, the present invention is not limited thereto. For example, the control unit 110 may switch operational control depending on the type of dog.

### REFERENCE SIGNS LIST

100 Air purifier
110 Control unit
170 Operation unit

1. An air purifier comprising:
a control unit configured to acquire occupancy information indicating whether or not a person is in a room,
wherein the control unit is configured to switch operational control based on a type of pet specified by a user and the occupancy information.

2. The air purifier according to claim 1,
wherein, when a person is not in the room, the control unit is configured to perform operational control and thus increase an airflow compared to that when a person is in the room.

3. The air purifier according to claim 1,
wherein the control unit is configured to change operational control and thus change the airflow in accordance with the type of pet.

4. The air purifier according to claim 1,
wherein the control unit is configured to change operational control and thus change a humidity in accordance with the type of pet.

5. The air purifier according to claim 1,
wherein, when a person is not in the room, the control unit is configured to perform operational control and thus lower an airflow direction compared to that when a person is in the room.

6. The air purifier according to claim 1, further comprising:
an operation unit configured to display an image,
wherein, when a person is not in the room, the control unit is configured to perform control and thus turn off the operation unit.
